(19) United States
(12) Patent Application Publication
(10) Pub. No.: US 2026/0024081 A1
(43) Pub. Date: Jan. 22, 2026

(54) DYNAMIC BLOCKCHAIN TRANSACTION PREFERENCES

(71) Applicant: Unstoppable Domains Inc., Las Vegas, NV (US)

(72) Inventors: Matthew Everett Gould, Atlanta, GA (US); Lisa Seacat DeLuca, Bozeman, MT (US)

(21) Appl. No.: 18/778,620

(22) Filed: Jul. 19, 2024

(51) Int. Cl. G06Q 20/38; G06Q 20/36; G06Q 20/40

(52) U.S. Cl. CPC G06Q 20/389; G06Q 20/367; G06Q 20/405

(57) ABSTRACT

A request associated with a blockchain transaction for a digital asset received. A determination is made that a crypto wallet holding the digital asset is associated with a transaction security option. A transaction authorization rule associated with the transaction security option is evaluated for verifying authorization for the blockchain transaction for the digital asset. Based on the evaluation of the transaction authorization rule, a determination is made whether to allow or deny the blockchain transaction for the digital asset.

### BACKGROUND OF THE INVENTION

Digital assets are commonly stored using a crypto wallet. Typically, a crypto wallet is configured with a public address and allows a user to safely store and manage digital assets using public-key cryptography and blockchain technology. For example, a crypto wallet provides a user interface for performing digital asset transactions such as receiving digital assets for storage in a user's crypto wallet and transferring digital assets stored in a user's crypto wallet to a different crypto wallet. Due to the ability to perform digital asset transactions, a common concern with crypto wallets is the unintended transfer of a valuable digital asset, whether malicious, inadvertent, or otherwise, out of a user's crypto wallet to another wallet, such as a third-party or malicious user's crypto wallet. Therefore, there exists a need for safeguards to improve the management of digital assets stored within a crypto wallet.

### BRIEF DESCRIPTION OF THE DRA WINGS

Various embodiments of the invention are disclosed in the following detailed description and the accompanying drawings.

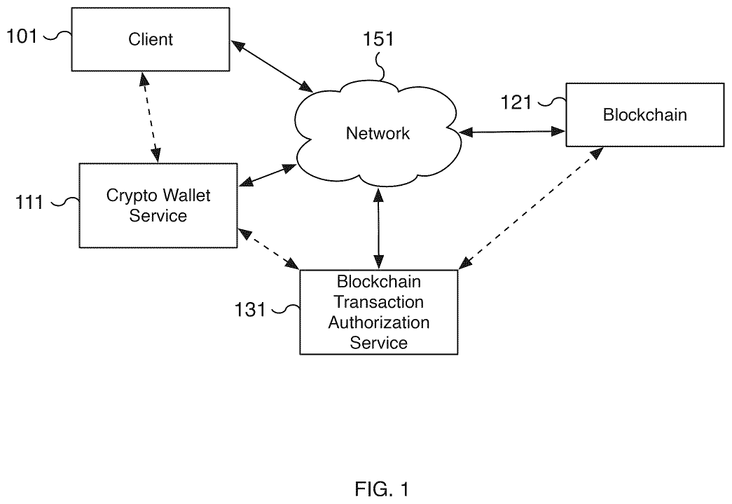

FIG. 1 is a block diagram illustrating an embodiment of a platform for authorizing crypto wallet transactions using dynamic blockchain transaction security options.

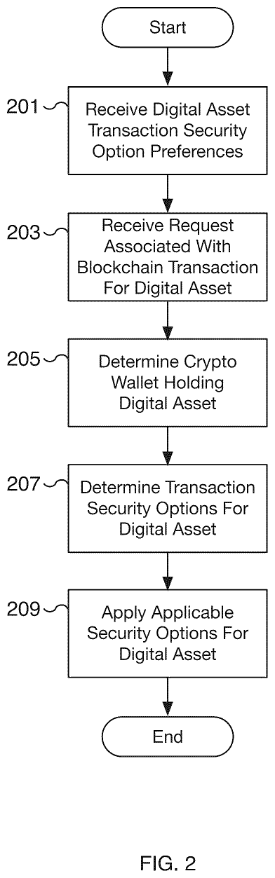

FIG. 2 is a flowchart illustrating an embodiment of a process for authorizing blockchain transactions using dynamic blockchain transaction security options.

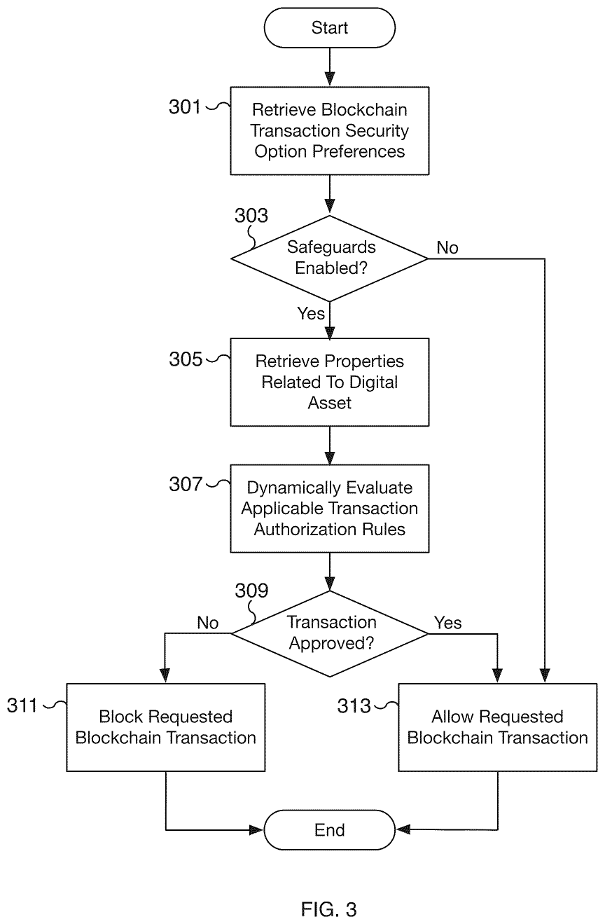

FIG. 3 is a flowchart illustrating an embodiment of a process for applying blockchain transaction authorization rules associated with blockchain transaction security options.

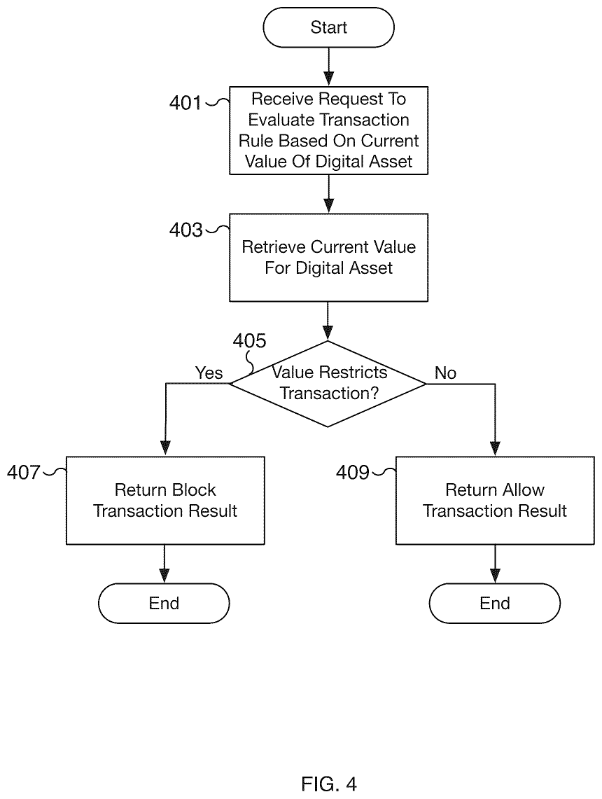

FIG. 4 is a flowchart illustrating an embodiment of a process for applying a security option to authorize a blockchain transaction.

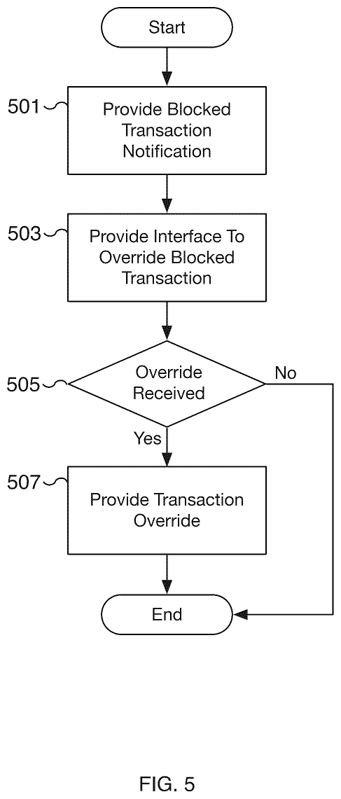

FIG. 5 is a flowchart illustrating an embodiment of a process for overriding a security option blocking a requested blockchain transaction.

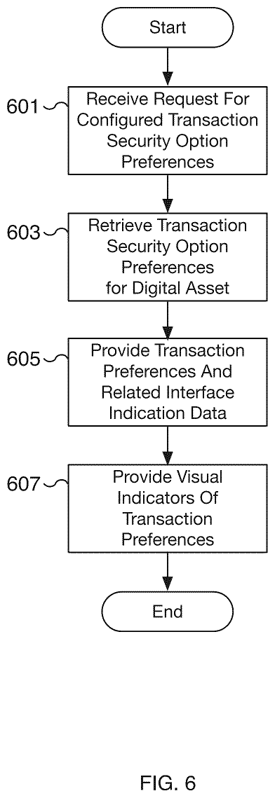

FIG. 6 is a flowchart illustrating an embodiment of a process for providing visual indicators within a crypto wallet for blockchain transaction security options associated with digital assets.

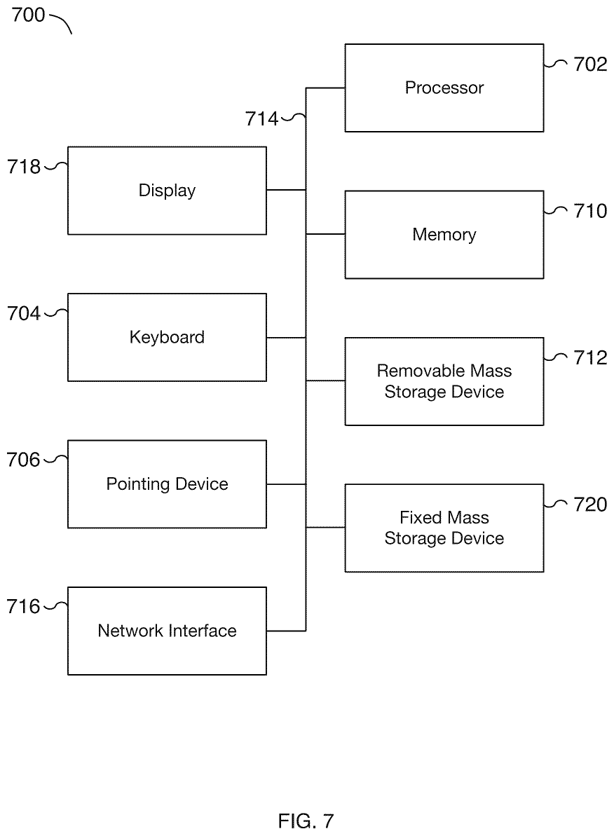

FIG. 7 is a functional diagram illustrating a programmed computer system for safeguarding crypto wallet transactions using dynamic blockchain transaction security options.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Dynamic blockchain transaction preferences are disclosed. For example, using the disclosed techniques, services, and/or technology platforms, blockchain transaction preferences are associated with digital assets stored within a crypto wallet. When a blockchain transaction is requested, such as the transfer of a digital asset, the applicable blockchain transaction preferences are identified and applied to the requested transaction. Example blockchain transaction preferences can include transaction security options and associated transaction authorization rules for the blocking or approval of a digital asset transaction. A configured transaction security option can be based on the digital asset's initial value, the digital asset's current market value, current and/or expired offers for the digital asset, previous prices associated with the digital asset (such as previous and/or last sold prices), a price associated with assets of a collection to which the asset belongs (such as a collection floor price), a configured threshold value, or another configured value or range of values. For example, all blockchain transactions to transfer a digital asset out of a wallet can be blocked when the current value, such as an estimated current market value, of the digital asset exceeds a configured threshold value. As another example, all blockchain transactions to transfer a digital asset out of a wallet can be blocked based on the purchase or initial price of the digital asset, based on the digital asset's type or category, and/or based on the change in value of the digital asset, such as a sudden increase or decrease in value. Other preferences can be configured as well including transaction security option preferences that are global such as preferences applied to an entire wallet or all users of a provided wallet service. In some embodiments, the preferences are assigned to digital assets based on individual user preferences. In some embodiments, transaction security options are configured on a per digital asset level of granularity, such as a blockchain transaction preference that is applied to only a specific and selected digital asset. In various embodiments, the outcome of applying a digital transaction security option preference is the approval or the blocking of a requested transaction for the digital asset based on the dynamic evaluation of an associated transaction authorization rule.

In some embodiments, the disclosed blockchain transaction preferences can include configuration settings and support for providing associated notifications associated with blockchain transaction security options, such as for successful transactions exceeding a certain value and/or for blocked transactions. Moreover, in some embodiments, an initially blocked transaction can be overridden, such as with the appropriate provided authorization. For example, in response to a notification that a blockchain transaction is blocked based on a configured blockchain transaction security option preference, a user can override the blocking of the requested transaction, such as by digitally signing an override approval to allow the blockchain transaction to be performed. In some embodiments, the override removes the preference, either temporarily (such as based on item, time, or the destination wallet, among other configuration settings) or permanently.

In some embodiments, visual indicators of configured blockchain transaction preferences are provided to the user. For example, a crypto wallet can display visual indicators, such as user interface elements, that correspond to blockchain transaction security option preferences that are applied to stored digital assets. In some embodiments, a crypto wallet can display a list of digital assets stored within the wallet. The displayed list of digital assets may include asset values associated with each digital asset such as the asset's initial price and/or current valuation. In various embodiments, for each digital asset with a configured blockchain transaction security option preference, one or more visual indicators can be displayed alongside the digital asset to identify the configured security option. For example, a lock icon may be displayed for a digital asset configured with a blockchain transaction security option preference that blocks all requested transactions. As another example, a lock icon with a currency symbol or value amount can be displayed for a digital asset configured with a blockchain transaction security option preference that blocks requested transactions based on the current value of the digital asset compared to a configured threshold value.

In some embodiments, a visual indicator of a configured blockchain transaction security option preference is used to manage the configured security option, such as to disable, enable, and/or modify the blockchain transaction security option. For example, a user can select a visual indicator associated with a blockchain transaction security option to change the configured valuation threshold used to block or approve an associated transaction. As another example, a user can select a visual indicator associated with a blockchain transaction security option to temporarily disable the dynamic evaluation of its associated transaction authorization rule. In some embodiments, the displayed visual indicator is an interactive user interface element and/or is use to initiate to an interactive user interface element for configuring the blockchain transaction security option for the associated digital asset.

In some embodiments, a visual indicator of the blockchain transaction security option can have an associated active or inactive state corresponding to whether the blockchain transaction preference is active or inactive. For example, a blockchain transaction security option that has been temporarily disabled, such as for a specific length of time, for a specific target public address, or for a value range, etc., can be shown as inactive or deactivated. In some embodiments, the deactivation is shown using a grayed out visual indicator or another visual meaning to visually indicate a deactivated blockchain transaction security option. For blockchain transaction security options that are deactivated temporarily based on a time, a countdown timer can be shown along with the visual indicator for the inactive (or active) blockchain transaction security option. Similarly, blockchain transaction security options can be temporarily activated, such as for a length of time or until an expiration date. In some embodiments, the active visual indicator for the blockchain transaction security option is shown with a corresponding time, such as the remaining time the security option will be active.

In various embodiments, the disclosed dynamic blockchain transaction preferences including the blockchain transaction security option preferences and their associated transaction authorization rules provide additional safeguards for the management of blockchain digital assets. The blockchain transaction preferences can be applicable for many types of crypto wallets including traditional crypto wallets and multi-party computation (MPC) crypto wallets. The advantages of the disclosed dynamic blockchain transaction preferences include significantly improved security and useability particularly for wallets with high value digital assets and/or a large number of digital assets. Using the disclosed dynamic blockchain transaction preferences, a crypto wallet can implement visual indicators for digital assets configured with blockchain transaction security options. In various embodiments, the displayed visual indicators allow a user to visually identify which digital assets are actively being safeguarded and provide an interactive user interface for modifying the configured preferences. When shown alongside a list of assets, the collection of visual indicators can additionally provide the user with a visual overview of the active blockchain transaction preferences for the crypto wallet.

In some embodiments, a request associated with a blockchain transaction for a digital asset is received. For example, a request is received to transfer a digital asset, such as a non-fungible token (NFT) stored in a user's crypto wallet, as part of selling the digital asset to another party. In some embodiments, the request is a malicious request attempting to transfer a digital asset from a user's wallet to a malicious third-party. In some embodiments, a determination is made that a crypto wallet holding the digital asset is associated with a transaction security option. For example, one or more different dynamically evaluated transaction security options used to restrict blockchain transactions can be associated with a digital asset held by a crypto wallet. In some embodiments, a transaction authorization rule associated with the transaction security option is evaluated for verifying authorization for the blockchain transaction for the digital asset. The different types of transaction security options and their associated transaction authorization rules can be configured for a digital asset to implement different approaches for blockchain transaction security and whether to allow or deny a requested transaction. For example, one security option can deny all transactions. Another security option can deny transactions only if the digital asset has a current value that exceeds a configured threshold amount. Other security options are appropriate as well and can be based on the value of the digital asset, including its initial value, change in value, and/or current market value, as well as on the asset type, a transfer source of the digital asset (such as a public address from where the asset was transferred from), and/or a requested destination for the digital asset (such as the intended recipient's crypto wallet). In various embodiments, using a corresponding security option, a user can deny all requested transactions to transfer digital assets purchased from a particular seller, group, or collective with a specified source public address or source public crypto wallet address. Similarly, using a corresponding different security option, a requested digital asset transfer can be denied if the recipient address belongs to a particular public address or group of addresses, such as a recipient specified by an address book. In various embodiments, for each different transaction security option, a different transaction authorization rule can be configured to implement the blockchain transaction restriction of the security option.

In some embodiments, based on the evaluation of the transaction authorization rule, a determination is made to allow or deny the blockchain transaction for the digital asset. For example, in the event the digital asset meets the requirements set by the security option to allow the transaction, the blockchain transaction is allowed (or approved) for the digital asset. However, in the event the digital asset does not meet the requirements set by the security option to allow the transaction, the requested blockchain transaction is blocked (or denied). In various embodiments, the transfer of a digital asset out of a crypto wallet can be blocked in the event the requirements of the selected transaction security option are not met when the transaction authorization rule associated with the security option is evaluated. For example, a selected transaction security option may require that a digital asset have a current market value under a threshold value. In the event the evaluation of the associated transaction authorization rule determines that the current market value is below the threshold value, a transfer transaction of the digital asset is allowed. However, in the event the evaluation of the associated transaction authorization rule determines that the current market value exceeds the threshold value, a transfer transaction of the digital asset is denied.

In some embodiments, a transaction security option is enabled for a digital asset based on a selection criterion. For example, the selection criterion can be based on the crypto wallet holding the digital asset, resulting in the transaction security option being applied to every digital asset held by the crypto wallet. As another example, the selection criterion can be based on an owner associated with the crypto wallet, resulting in the transaction security option being applied to every digital asset held by every crypto wallet of the owner. In some embodiments, the selection criterion is based on a category type of the digital asset. For example, the transaction security option can be applied to every digital asset belonging to a particular asset type, class, category, collection, or another grouping type. In some embodiments, selection criterion is based on a former crypto wallet address associated with the digital asset. For example, the transaction security option can be applied to every digital asset acquired from or previously owned by a particular author, artist, seller, and/or collective, etc. In various embodiments, the selection criterion can be applied for only specific digital assets within the crypto wallet, universally for all digital assets in the crypto wallet, universally for all users of a crypto wallet service, or universally for all crypto wallets of a particular user, among other available application approaches.

FIG. 1 is a block diagram illustrating an embodiment of a platform for authorizing crypto wallet transactions using dynamic blockchain transaction security options. In the example shown, the crypto wallet transactions authorization platform includes client 101, crypto wallet service 111, blockchain 121, blockchain transaction authorization service 131, and network 151. Client 101 is a network client used to access crypto wallet service 111. Crypto wallet service 111 is a crypto wallet application service that uses blockchain 121 and offers crypto wallet functionality as a service for client 101. Blockchain transaction authorization service 131 is a service for authorizing blockchain transactions requested on digital assets managed using crypto wallet service 111 for client 101. The blockchain transaction security option preferences for a digital asset can be managed by blockchain transaction authorization service 131 and applied whenever a transaction for a managed digital asset is requested. In various embodiments, the transactions authorized by blockchain transaction authorization service 131 are tracked on blockchain 121.

In the diagram of FIG. 1, client 101, crypto wallet service 111, blockchain 121, and blockchain transaction authorization service 131 are communicatively connected via network 151. In some embodiments, network 151 is the Internet. The solid bi-directional arrows between each of client 101, crypto wallet service 111, blockchain 121, and blockchain transaction authorization service 131 to network 151 represent network connectivity via network 151. The dashed bi-directional arrows between the different components of FIG. 1 correspond to two different network endpoints of a network connection established via network 151. The connections represented by the dashed bi-directional arrows correspond to network connections used for verifying and potentially approving and performing a blockchain transaction on a digital asset tracked on blockchain 121 of client 101, where the digital asset is managed using crypto wallet service 111 using blockchain transaction security option preferences validated by blockchain transaction authorization service 131.

In some embodiments, additional entities including entities corresponding to different services exist but are not shown in FIG. 1. For example, services for looking up the current market value of a digital asset can exist and be accessed by the entities of FIG. 1 including by client 101, crypto wallet service 111, and/or blockchain transaction authorization service 131. For example, in some embodiments, blockchain transaction authorization service 131 can query a pricing service for looking up the current market value of a non-fungible token (NFT) stored as a digital asset using crypto wallet service 111. As another example, blockchain transaction authorization service 131 can query an exclusion list of public addresses corresponding to digital wallets associated with malicious users.

In some embodiments, client 101 is a network client and corresponds to a user of a crypto wallet accessed via crypto wallet service 111. Client 101 can be a computing device such as a laptop, mobile device, desktop, or another network computing client capable of accessing a crypto wallet via crypto wallet service 111. In various embodiments, crypto wallet service 111 can be accessed via an application including a desktop or mobile application, via a web browser, via a web browser extension, and/or via an application programming interface (API) of crypto wallet service 111. For example, a client application on client 101 is used to access crypto wallet service 111 and allows client 101 to manage digital assets for a crypto wallet offered by crypto wallet service 111. In various embodiments, client 101 is also used to manage blockchain transaction security option preferences for digital assets via crypto wallet service 111 and/or blockchain transaction authorization service 131. For example, client 101 can set blockchain transaction security option preferences that are dynamically evaluated to approve or deny blockchain transactions for a digital asset managed via crypto wallet service 111.

In some embodiments, crypto wallet service 111 offers crypto wallet functionality for clients such as client 101. In various embodiments, the associated crypto wallet offered by crypto wallet service 111 is a digital wallet that implements public-key cryptography and blockchain technology to manage digital assets such as non-fungible tokens (NTFs), cryptocurrencies or digital currencies, smart contracts, and/or voting tokens, among other digital assets. The offered services can be accessed via a variety of methods including via an application programming interface (API), a web interface, and/or a server-side interface for a corresponding client application such as a desktop or mobile application. In various embodiments, other techniques for accessing wallet services of crypto wallet service 111 are appropriate as well including via Web3 applications. In some embodiments, crypto wallet service 111 is a decentralized service and/or a Web3 application. In various embodiments, the digital assets stored with a crypto wallet offered via crypto wallet service 111 are tracked using blockchain 121 and crypto wallet service 111 offers services such as the management of cryptographic keys for a crypto wallet as well as a public address for a crypto wallet. Using the disclosed techniques and technologies, digital assets stored in a crypto wallet of crypto wallet service 111 can be safeguarded using blockchain transaction security options. For example, in some embodiments, a user can configure and/or manage blockchain transaction security option preferences for digital assets via crypto wallet service 111. The configured blockchain transaction preferences allow a user to enable safeguards that are dynamically evaluated to block or approve a blockchain transaction associated with a digital asset. In some embodiments, crypto wallet service 111 utilizes blockchain transaction authorization service 131 to authorize requested blockchain transactions and to evaluate authorization rules associated with configured blockchain transaction security options. For example, crypto wallet service 111 can utilize blockchain transaction authorization service 131 to apply and/or evaluate active blockchain transaction security options for a requested and/or desired blockchain transaction to be performed on a digital asset managed via crypto wallet service 111. In some embodiments, crypto wallet service 111 provides support for displaying visual indicators such as user interface elements used to inform a user of a crypto wallet of configured blockchain transaction preferences for digital assets. In some embodiments, displayed visual indicators for blockchain transaction preferences are interactive user interface elements that allow a user to manage blockchain transaction security option preferences.

In some embodiments, blockchain 121 is used by crypto wallet service 111 and/or blockchain transaction authorization service 131 to manage and/or store digital assets such as non-fungible tokens (NFTs), cryptocurrencies, and smart contracts, among other types of digital assets. In some embodiments, blockchain 121 is a public ledger and can be distributed across multiple computing devices. In various embodiments, blockchain 121 may be a multi-layer blockchain. In connection with crypto wallet service 111 and/or blockchain transaction authorization service 131, transactions for digital assets recorded on blockchain 121 can be safeguarded by dynamically evaluating blockchain transaction authorization rules associated with enabled transaction security options.

In some embodiments, blockchain transaction authorization service 131 is a service for authorizing blockchain transactions on a digital asset by dynamically evaluating transaction authorization rules associated with configured blockchain transaction preferences. In some embodiments, blockchain transaction authorization service 131 is implemented as a service distinct from crypto wallet service 111 and may be accessible to/from one or more different crypto wallet services including crypto wallet service 111. In some embodiments, blockchain transaction authorization service 131 is implemented as part of crypto wallet service 111. In various embodiments, blockchain transaction authorization service 131 offers security options to determine whether to approve or deny a requested blockchain transaction based on dynamically evaluating transaction authorization rules of blockchain transaction security options configured for the associated digital asset. Example blockchain transaction preferences include preferences to allow/deny a transaction based on the value of a digital asset, the source and/or destination address associated with a digital asset (such as the public address of the crypto wallet for an intended recipient), and the digital asset's type or category, among other preferences and/or criteria. In various embodiments, the digital assets safeguarded by security options offered by blockchain transaction authorization service 131 can be any type of digital asset including non-fungible tokens (NFTs), smart contracts, voting tokens, and digital currencies, among others.

In some embodiments, blockchain transaction authorization service 131 provides an application programming interface (API) for the authorization of blockchain transactions. For example, blockchain transaction authorization service 131 can be accessed via crypto wallet service 111 to authorize a requested blockchain transaction such as the transfer of a valuable digital asset to a third-party digital wallet. Depending on configured blockchain transaction security option preferences, the requested transaction may be approved or denied. In some embodiments, blockchain transaction authorization service 131 provides an override service for approving blockchain transactions that are initially denied. For example, blockchain transaction authorization service 131 provides a service that allows a user to digitally sign and/or digitally verify an approval for a requested blockchain transaction that is initially denied.

In various embodiments, blockchain transaction authorization service 131 stores and/or manages blockchain transaction security option preferences for digital assets. For example, the blockchain transaction preferences for a digital asset can be stored in a data store such as a database including a distributed database. In some embodiments, some or all data related to blockchain transaction preferences are stored using blockchain 121. In some embodiments, blockchain transaction authorization service 131 utilizes a third-party data store to securely store blockchain transaction preferences. For example, blockchain transaction authorization service 131 may use a secure distributed data store service for storing blockchain transaction security option preferences. In some embodiments, the blockchain transaction preferences are stored by a crypto wallet such as by crypto wallet service 111. In various embodiments, the transactions authorized by blockchain transaction authorization service 131 are tracked on blockchain 121.

In various embodiments, the components shown in FIG. 1 may exist in various combinations of software programs and/or hardware machines. Although single instances of some components have been shown to simplify the diagram, additional instances of any of the components shown in FIG. 1 may exist. For example, crypto wallet service 111, blockchain 121, and blockchain transaction authorization service 131 can each include one or more servers including distributed servers as well as shared or partially shared servers. For example, some servers of blockchain transaction authorization service 131 may include web application servers and/or database servers. As additional examples, client 101 is just one example of a potential client for accessing and managing digital assets via a crypto wallet, crypto wallet service 111 is just one example of a crypto wallet implementation for managing digital assets, and blockchain transaction authorization service 131 is just one example of a blockchain transaction authorization service for verifying blockchain transactions for digital assets using transaction authorization rules associated with configured blockchain transaction preferences. Additional instances of each may also exist. In some embodiments, components not shown in FIG. 1 may also exist.

FIG. 2 is a flowchart illustrating an embodiment of a process for authorizing blockchain transactions using dynamic blockchain transaction security options. For example, using the process of FIG. 2, a digital asset stored in a crypto wallet can be safeguarded using different transaction security options. The different transaction security options can be applied to selective digital assets based on a variety of selection criteria, such as by digital asset, by user, by crypto wallet, by crypto wallet service, by previous owner of the digital asset, etc. In some embodiments, the crypto wallet is implemented using crypto wallet service 111 of FIG. 1 and/or authorizations for the dynamic blockchain transactions are determined by a blockchain transaction authorization service such as blockchain transaction authorization service 131 of FIG. 1.

At 201, digital asset blockchain transaction security option preferences are received. For example, one or more blockchain transaction preferences are received for configuring security options for a digital asset, such as a non-fungible token (NFT), a smart contract, a voting token, or a cryptocurrency, among other types of digital assets. In some embodiments, the desired preferences are provided from a crypto wallet such as via a crypto wallet service. For example, a user of a crypto wallet can configure blockchain transaction security option preferences for safeguarding digital assets stored in the wallet. In some embodiments, a set of configured blockchain transaction preferences are set for a user and then applied for every wallet of the user. For example, a user can configure digital asset blockchain transaction security option preferences and each of the user's wallets and corresponding stored digital assets are configured with the same preferences. Other selection criteria for the security options are appropriate as well. For example, in some embodiments, a set of configured blockchain transaction preferences are applied for every crypto wallet of a crypto wallet service (such as a default setting regardless of user), for every digital asset with a particular property such as belonging to a particular digital asset type, class, collection, or category, owned by a previous owner or by one of a group of owners, having a particular purchase price, etc. For example, default security options can be enabled for digital asset purchases from a particular author, artist, seller, and/or collective. In some embodiments, the blockchain transaction preferences can be configured differently for each crypto wallet, and a new digital asset added to the crypto wallet is configured with the preferences associated with the crypto wallet. In some embodiments, the selection criteria are more exclusive and are based on specific token identifiers, such as unique token identifiers for specific digital assets or NFTs.

In some embodiments, the available different security options can include a variety of different transaction authorization rules that are dynamically evaluated when a transaction for a digital asset is requested. For example, a security option can be based on a configured threshold value associated with the digital asset. The configured threshold value can be a currency value that is evaluated against a value property of the digital asset to determine whether to approve or block a requested transaction. The referenced value property of the digital asset can be based on an estimated current market value of the digital asset, an initial value of the digital asset when added to the crypto wallet, a predicted future value of the digital asset, a current market value of a similar digital asset, a floor price of a collection in which the digital asset is associated with, or a previous purchase price associated with the digital asset, among other value properties. In some embodiments, a security option can be configured based on a change in valuation of the digital asset, such as to prevent the transfer of a digital asset that has rapidly risen or dropped in valuation.

In various embodiments, other transaction authorization rules can be implemented for security options such as rules based on crypto wallet addresses. For example, a security option can be configured to approve or block a blockchain transaction based on the recipient address of the requested blockchain transaction for the digital asset or the crypto wallet address of a previous owner of the digital asset. In some embodiments, the transaction authorization rule is based on a set of addresses such as crypto, contract, and/or contact addresses. For example, an address book may be used to describe a set of crypto wallet addresses that are compared against when determining whether to authorize a blockchain transaction on a digital asset. In some embodiments, the security option allows a user to block every requested blockchain transaction for the digital asset, essentially locking the digital asset to the user's crypto wallet. In various embodiments, enabled (or active) security options can be disabled (or deactivated) by changing blockchain transaction preferences. In some embodiments, a security option can have an active and inactive (or enabled and disabled) state. For example, a security option can be temporarily enabled or disabled, such as only for a certain length of time.

In various embodiments, whenever preferences for a blockchain transaction security option are changed, the changes must be authenticated and/or verified. For example, the received changes may be authorized by a user of the crypto wallet or in the case of a multi-party computation (MPC) wallet, by the multiple participants of the MPC wallet. In some embodiments, the authentication can be in the form of one or more digital signatures, biometric signatures, authorization codes, or certifications verifying the user's identity or the identities of participants. In some embodiments, the authentication includes other forms of verification and/or is a combination of different forms of verification.

At 203, a request associated with a blockchain transaction for a digital asset is received. For example, a request to perform a blockchain transaction on a digital asset such as to transfer a digital asset to a third-party crypto wallet is received. In some embodiments, the requested transaction is an authentic transaction desired by the owner that should be approved. However, in some scenarios, the requested transaction may be a malicious or unintended transaction that should be blocked. In various embodiments, the request received can indicate a target digital asset along with a public address such as a crypto wallet address for the intended recipient of the digital asset. Depending on the nature of the transaction, the intended recipient may be an authentic buyer or may be a malicious user.

At 205, the crypto wallet holding the digital asset is determined. For example, the crypto wallet associated with the digital asset is determined. In some embodiments, the wallet holding the digital asset is confirmed by accessing the associated blockchain used to track the digital asset. In various embodiments, the digital asset may be held by one or more parties including by a single user of a crypto wallet or by multiple participants of a multi-party computation (MPC) crypto wallet.

At 207, blockchain transaction security options are determined for the digital asset. For example, the blockchain transaction security options configured for a digital asset stored in a particular crypto wallet are determined. In some embodiments, each of the configured blockchain transaction security options has a corresponding blockchain authorization rule. In various embodiments, the blockchain transaction security options are applied, assigned, and/or enabled for a digital asset based on selection criteria. For example, a blockchain transaction security option may be active (or enabled) for a digital asset based on the asset belonging to a particular user's wallet, being stored in a wallet of a particular crypto wallet service, belonging to a particular digital asset type, class, or category, and/or being transferred from a particular seller, author, or source address, among other selection criteria. In various embodiments, a digital asset can also be individually selected for a security option. Once a security option is selected, the option is configured for the dynamic evaluation of an associated transaction authorization rule when a blockchain transaction is requested for the digital asset. The transaction authorization rule is used to authenticate a requested blockchain transaction allowing desired transactions to be approved (or allowed) and undesired transactions to be blocked (or denied). The parameters and/or preferences of the security option can differ depending on the type of security option and the particular transaction authorization rule. In various embodiments, the associated blockchain transaction security options are determined for the digital asset based on one or more selection criterion. For example, blockchain transaction security options can be enabled for a digital asset based on one or more selection criteria.

At 209, applicable blockchain transaction security options are applied. For example, enabled blockchain transaction security options for the digital assets are evaluated to determine whether to approve or block the request received at 203. In various embodiments, multiple security options can be enabled, and multiple associated transaction authorization rules may be dynamically evaluated. In the event multiple security options are enabled, in some embodiments, all enabled security options must determine that the requested transaction should be allowed in order for the requested transaction to be allowed. Alternatively, in some embodiments, a single enabled security option determining that the requested transaction should be allowed can result in the transaction being allowed.

FIG. 3 is a flowchart illustrating an embodiment of a process for applying blockchain transaction authorization rules associated with blockchain transaction security options. For example, using the process of FIG. 3, applicable blockchain transaction preferences for a digital asset are retrieved and used to evaluate enabled transaction authorization rules. The evaluated transaction authorization rules are associated with the blockchain transaction security options configured for the digital asset. In some embodiments, the process of FIG. 3 is performed in response to a request for a blockchain transaction on a digital asset. In some embodiments, the process of FIG. 3 is performed at 205, 207, and/or 209 of FIG. 2 by a blockchain transaction authorization service such as blockchain transaction authorization service 131 of FIG. 1. In some embodiments, portions of the process of FIG. 3 can be performed by a crypto wallet such as by crypto wallet service 111 of FIG. 1.

At 301, blockchain transaction security option preferences are retrieved. For example, all configured preferences associated with blockchain transaction security options for a digital asset are retrieved. In some embodiments, the retrieval of configured preferences is performed at least in part by a crypto wallet and/or by a blockchain transaction authorization service. For example, in some embodiments, a crypto wallet may store the blockchain transaction security option preferences. In some embodiments, the preferences are stored by the blockchain transaction authorization service including in connection with the associated crypto wallet.

At 303, a determination is made whether blockchain transaction safeguards are enabled. In the event one or more blockchain transaction safeguards are enabled, processing proceeds to 305. In the event that no blockchain transaction safeguards are enabled, processing proceeds to 313 where the associated requested transaction is allowed since no blockchain transaction security options are enabled.

At 305, properties related to the digital asset are retrieved. For example, one or more properties including dynamically determined properties are retrieved. In some embodiments, the retrieved properties include the current value, current market value, and/or predicted future values of the digital asset. In some embodiments, the retrieved properties can include previous owners of the digital asset, previous prices of the digital asset, types, classes, collections, or categories that the digital asset belongs to including valuations for related assets, the value of current and/or expired offers for the digital asset, the value of the crypto wallet used to store the digital asset (including valuations for other assets in the wallet), and any addresses associated with the requested transaction such as a recipient crypto wallet address. In some embodiments, the valuations for related assets include a floor price of a collection in which the digital asset is associated with. In some embodiments, external services including third-party services such as valuation and/or look-up services are accessed to retrieve certain properties related to the digital asset, such as the current market value or previous valuations of the digital asset. The various services used to provide valuations can apply different techniques for determining valuation including predicted future valuation. For example, the services can utilize artificial intelligence models trained on digital asset properties such as price history, collection prices, past offers, market sentiment, etc.

At 307, applicable transaction authorization rules are dynamically evaluated. For example, the enabled security options are applied by evaluating the transaction authorization rules associated with the enabled security options. In various embodiments, the authorization rules are dynamically evaluated and may be evaluated using values for properties retrieved at 305. For example, the current market value of a digital asset can be compared to configured threshold values to determine whether to approve or block a requested transaction such as an action to transfer a digital asset out of its current crypto wallet. In some embodiments, an estimated price or price range for the digital asset is compared to one or more configured and/or dynamically calculated threshold values to determine whether to approve or block a requested transaction. For example, the value of the digital asset can be an estimated current value or predicted future value. The estimated and/or predicted value of the digital asset can be further based on price history, prices of related assets such as assets from the same or similar collections, current and/or expired offers, and/or other property values retrieved at 305. Similarly, the dynamically calculated threshold values can be similarly based on price history, prices of related assets such as assets from the same or similar collections (such as a floor price of a collection in which the digital asset is associated with), current and/or expired offers, and/or other property values retrieved at 305.

At 309, a determination is made whether the requested blockchain transaction has been approved. In the event the transaction has not been approved, processing proceeds to 311. In the event the transaction has been approved, processing proceeds to 313.

At 311, the requested blockchain transaction is blocked. For example, the requested blockchain transaction is blocked for failing to meet requirements of a security option. In some embodiments, a single enabled security option can block or deny a requested blockchain transaction. In some embodiments, all enabled security options are required to determine that the requested blockchain transaction should be blocked in order to block the requested transaction. In various embodiments, a notification is initiated in the event a requested blockchain transaction is blocked. For example, the user or participants of a wallet are notified when a requested blockchain transaction is blocked. The provided notification can include a description and cause for the blocked transaction. In some embodiments, the notification includes a mechanism to allow the user of the wallet (or participants of a multi-party computation (MPC) wallet) to override the blocking of the transaction.

At 313, the requested blockchain transaction is allowed. For example, the requested blockchain transaction is approved and the transaction is allowed to execute. In some embodiments, a single enabled security option can allow a requested blockchain transaction to execute. In some embodiments, all enabled security options are required to determine that the requested blockchain transaction should be approved in order to allow the requested transaction to execute. In various embodiments, a notification is initiated in the event a requested blockchain transaction with an enabled security option is allowed. For example, the user or participants of a wallet are notified when a requested blockchain transaction is allowed for a digital asset with an enabled blockchain transaction security option.

FIG. 4 is a flowchart illustrating an embodiment of a process for applying a security option to authorize a blockchain transaction. In some embodiments, the process of FIG. 4 is performed in response to a request for authorization to perform a transaction on a digital asset. For example, using the process of FIG. 4, a blockchain transaction security option based on the current value of the digital asset is used to authorize a requested transaction on the digital asset. In some embodiments, the authorization is performed at 205, 207, and/or 209 of FIG. 2 and/or at 305, 307, 309, 311, and/or 313 of FIG. 3 by a blockchain transaction authorization service such as blockchain transaction authorization service 131 of FIG. 1. In some embodiments, portions of the process of FIG. 4 can be performed by a crypto wallet such as by crypto wallet service 111 of FIG. 1.

At 401, a request to evaluate a transaction authorization rule based on the current value of a digital asset is received. For example, a security option can be configured to restrict the authorization of a transaction based on the digital asset's current value. The associated restriction for the security option can be based on a configured threshold value or configured range of values. For example, a transaction can be approved only in the event the current value of the digital asset is below (or above) the configured threshold value or within a configured range of values. The request received at 401 can reference the specific configured threshold value (or range of values) and identify the digital asset along with the enabled security option and associated transaction authorization rule.

At 403, a current value for the digital asset is retrieved. For example, the current value or current market value for the digital asset is determined. In some embodiments, the current value is determined using a third-party lookup or valuation service. For example, a pricing service can be queried with a token identifier for the digital asset to retrieve the current market value or estimated value of the digital asset. In some embodiments, in the event no current value can be retrieved, the transaction is automatically denied. For example, in the event one or more of the approved pricing or valuation services are currently unavailable or unresponsive, the requested transaction can be blocked. In some embodiments, the transaction is temporarily blocked until the current value of the digital asset can be determined. In some embodiments, the current value is an estimated and/or predicted value and can be based on predicted future values of the digital asset, on prices of related digital assets, on existing and/or expired offers for the digital asset, etc.

At 405, a determination is made whether the current value of the digital asset restricts the transaction. In the event the current value of the digital asset restricts the transaction, processing proceeds to 407. In the event the current value of the digital asset does not restrict the transaction, processing proceeds to 409.

At 407, a block transaction result is returned. For example, in response to a request to perform a transaction on the digital asset, a block result indicating the request should be blocked (or denied) is returned.

At 409, an allow transaction result is returned. For example, in response to a request to perform a transaction on the digital asset, an allow result indicating the request has been authorized and should be allowed is returned.

FIG. 5 is a flowchart illustrating an embodiment of a process for overriding a security option blocking a requested blockchain transaction. For example, using the process of FIG. 5, a blockchain transaction that is denied by an enabled blockchain transaction security option can be overridden to allow the transaction to be executed. In various embodiments, the process allows a user or participants of a wallet to intervene when a requested transaction is blocked. In some embodiments, the authorization is performed at 209 of FIG. 2, at 311 of FIG. 3, and/or at 407 of FIG. 4 in response to a blocked transaction. In some embodiments, the process of FIG. 5 is performed by a blockchain transaction authorization service such as blockchain transaction authorization service 131 of FIG. 1. In some embodiments, portions of the process of FIG. 5 can be performed by a crypto wallet such as by crypto wallet service 111 of FIG. 1.

At 501, a notification of a blocked transaction is provided. For example, a user of a crypto wallet or participants of a multi-party computation (MPC) wallet receive a notification that a requested transaction for a digital asset has been blocked. The notification can include the transaction rule that was evaluated and that resulted in blocking the transaction along with an identifier of the relevant digital asset.

At 503, an interface to override the blocked transaction is provided. For example, an interface including a user interface in the form of a user dialog, user interface elements, text messages, etc. is provided that allows the blocking of the requested transaction to be overridden. In some embodiments, the interface for overriding the transaction is provided to and/or is accessible to any authorized user of the crypto wallet. For example, the provided interface may be a user interface for providing a digital signature, a biometric signature, an authorization code, a certification verifying the user's identity (such as a third-party identity verification certification), and/or a combination of different forms of authorization. In some embodiments, a user's identity can be verified using government, business, or another entity issued identification and/or a service for verifying a user's government business, or another entity issued identification. In some embodiments, the interface is presented within the crypto wallet and/or via another interface such as via email, text message, a mobile application, a client browser, etc.

At 505, a determination is made whether an authorized override is received. In the event an authorized override is received, processing proceeds to 507. In the event an authorized override is not received, the override process completes and the blocked requested transaction remains blocked.

At 507, a transaction override is provided. For example, an override result is provided that authorized the execution of the previously blocked blockchain transaction. In various embodiments, the authorized override is logged and/or a notification/confirmation is provided that the override has been authenticated. In response to the provided transaction override, the previously blocked transaction can now be executed.

FIG. 6 is a flowchart illustrating an embodiment of a process for providing visual indicators within a crypto wallet for blockchain transaction security options associated with digital assets. For example, using the process of FIG. 6, a user interface for a crypto wallet can be augmented to support user interface elements associated with configured blockchain transaction security options. The provided and displayed visual indicators help the user understand the enabled security options and also provided an interface for initiating the management of security options. In some embodiments, the process of FIG. 6 is performed by a crypto wallet such as crypto wallet service 111 of FIG. 1 in connection with a blockchain transaction authorization service such as blockchain transaction authorization service 131 of FIG. 1.

At 601, a request for the configured blockchain transaction security options is received. For example, a crypto wallet service initiates a request for the configured blockchain transaction safeguards. In various embodiments, the request is received by the blockchain transaction authorization service. In some embodiments, the preferences are stored and/or cached by the crypto wallet and the request for the configured blockchain transaction security options is processed by the crypto wallet.

At 603, the blockchain transaction security option preferences for digital assets are retrieved. For example, the different security option preferences configured for the digital assets stored in a crypto wallet are retrieved. In some embodiments, the preferences are stored and retrieved by the blockchain transaction authorization service and/or via the crypto wallet. The retrieved preferences can include what digital assets are configured with security options including configuration parameters associated with the configured preferences. In some embodiments, one or more of the configured security options can include a configuration parameter for enabling and disabling (including temporarily enabling or disabling) a security option.

In various embodiments, the security option preferences may be retrieved according to different selection criteria. For example, digital assets can be configured individually or by a different selection criterion such as by wallet, by user, by collection, etc. In various embodiments, the applicable transaction preferences are identified and retrieved. For example, transaction preferences set at the layer of the crypto wallet to apply to all digital assets of the wallet are retrieved. Similarly, transaction preferences set at the layer of a user to apply to all digital assets of all wallets of the user are also retrieved.

At 605, transaction preferences and related interface indication data are provided. For example, the security option preferences including configuration preferences, settings, and/or interface indication data retrieved at 603 are provided in response to the request received at 601. In some embodiments, the requester is a crypto wallet service or application, which can process the provided preferences and related interface indication data for presenting user interfaces for managing and/or displaying the configured security options. In various embodiments, the provided related interface indication data can include preferences associated with the transaction authorization rules such as configured threshold values and/or restrictions used for authenticating blockchain transactions. In some embodiments, the provided interface indication data can include media assets such as icons, labels, descriptions, and/or other visual interface and/or visual indicator data.

At 607, visual indicators of transaction preferences are provided. For example, visual indicators can be provided including standard or suggested visual icons, text, labels, descriptions, and values associated with configured blockchain transaction security options. In some embodiments, the visual indicators are presented to a user of the crypto wallet such as within a crypto wallet user interface. For example, visual icons and dialogs can be presented to the user to indicate the configuration of a security option associated with a digital asset, wallet, and/or user of the wallet. In addition to displaying that a security option has been configured, configuration parameters and preferences of a configured security option can also be displayed and/or visually indicated. For example, the provided configuration preferences, parameters, and/or indication data can include whether a configured security option for a digital asset is active or inactive, the length of time associated with a temporarily active (or inactive) security option, a configured threshold value for a security option, and/or the relationship between the current value of a digital asset and a configured threshold value for a security option, among other information. Examples of visual indicators include specific icons and/or visual/graphical assets such as a lock icon or a lock icon with an overlaid currency value and/or expiration time. In some embodiments, the visual indicators provide information on whether a configured security option is active or inactive or whether a current transaction would be approved or blocked. For example, an inactive but configured security option may be shown as greyed out or with another visual indication of its inactive status.

In some embodiments, the provided visual indicators of transaction preferences are interactive user interface elements. For example, a user can interact with the provided visual indicators or associated user interface elements to manage the configured dynamic blockchain transaction preferences. In some embodiments, the visual indicators initiate additional user interfaces for configuring transaction preferences such as setting threshold values, enabling or disabling the security option, setting an expiration time for the security option, etc.

FIG. 7 is a functional diagram illustrating a programmed computer system for safeguarding crypto wallet transactions using dynamic blockchain transaction security options. As will be apparent, other computer system architectures and configurations can be utilized for supporting dynamic blockchain transaction security options. Examples of computer system 700 include client 101 of FIG. 1, one or more computers of crypto wallet service 111 of FIG. 1, one or more computers included in blockchain 121 of FIG. 1, and one or more computers of blockchain transaction authorization service 131 of FIG. 1. Computer system 700, which includes various subsystems as described below, includes at least one microprocessor subsystem (also referred to as a processor or a central processing unit (CPU)) 702. For example, processor 702 can be implemented by a single-chip processor or by multiple processors. In some embodiments, processor 702 is a general purpose digital processor that controls the operation of the computer system 700. Using instructions retrieved from memory 710, the processor 702 controls the reception and manipulation of input data, and the output and display of data on output devices (e.g., display 718). In various embodiments, one or more instances of computer system 700 can be used to implement at least portions of the processes of FIGS. 2-6.

Processor 702 is coupled bi-directionally with memory 710, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 702. Also as is well known in the art, primary storage typically includes basic operating instructions, program code, data and objects used by the processor 702 to perform its functions (e.g., programmed instructions). For example, memory 710 can include any suitable computer-readable storage media, described below, depending on whether, for example, data access needs to be bi-directional or unidirectional. For example, processor 702 can also directly and very rapidly retrieve and store frequently needed data in a cache memory (not shown).

A removable mass storage device 712 provides additional data storage capacity for the computer system 700, and is coupled either bi-directionally (read/write) or unidirectionally (read only) to processor 702. For example, storage 712 can also include computer-readable media such as magnetic tape, flash memory, PC-CARDS, portable mass storage devices, holographic storage devices, and other storage devices. A fixed mass storage 720 can also, for example, provide additional data storage capacity. The most common example of mass storage 720 is a hard disk drive. Mass storages 712, 720 generally store additional programming instructions, data, and the like that typically are not in active use by the processor 702. It will be appreciated that the information retained within mass storages 712 and 720 can be incorporated, if needed, in standard fashion as part of memory 710 (e.g., RAM) as virtual memory.

In addition to providing processor 702 access to storage subsystems, bus 714 can also be used to provide access to other subsystems and devices. As shown, these can include a display monitor 718, a network interface 716, a keyboard 704, and a pointing device 706, as well as an auxiliary input/output device interface, a sound card, speakers, and other subsystems as needed. For example, the pointing device 706 can be a mouse, stylus, track ball, or tablet, and is useful for interacting with a graphical user interface.

The network interface 716 allows processor 702 to be coupled to another computer, computer network, or telecommunications network using a network connection as shown. For example, through the network interface 716, the processor 702 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 702 can be used to connect the computer system 700 to an external network and transfer data according to standard protocols. For example, various process embodiments disclosed herein can be executed on processor 702, or can be performed across a network such as the Internet, intranet networks, or local area networks, in conjunction with a remote processor that shares a portion of the processing. Additional mass storage devices (not shown) can also be connected to processor 702 through network interface 716.

An auxiliary I/O device interface (not shown) can be used in conjunction with computer system 700. The auxiliary I/O device interface can include general and customized interfaces that allow the processor 702 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 7 is but an example of a computer system suitable for use with the various embodiments disclosed herein. Other computer systems suitable for such use can include additional or fewer subsystems. In addition, bus 714 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a request associated with a blockchain transaction for a digital asset;
determining that a crypto wallet holding the digital asset is associated with a transaction security option;
evaluating a transaction authorization rule associated with the transaction security option for verifying authorization for the blockchain transaction for the digital asset; and
based on the evaluation of the transaction authorization rule, determining whether to allow or deny the blockchain transaction for the digital asset.

2. The method of claim 1, wherein the transaction authorization rule is based on a configured threshold value associated with the digital asset.

3. The method of claim 2, wherein the configured threshold value is evaluated against an estimated current market value of the digital asset, an initial value of the digital asset when added to the crypto wallet, a predicted future value of the digital asset, a current market value of a similar digital asset, a floor price of a collection in which the digital asset is associated with, or a previous purchase price associated with the digital asset.

4. The method of claim 1, wherein the transaction authorization rule is based on a change in valuation of the digital asset.

5. The method of claim 1, wherein the transaction security option is based on a crypto wallet address of a previous owner of the digital asset.

6. The method of claim 1, wherein the transaction authorization rule is configured to block every requested blockchain transaction for the digital asset.

7. The method of claim 1, wherein the transaction security option is active for only a configured length of time.

8. The method of claim 1, wherein the transaction security option is enabled for the digital asset based on a selection criterion.

9. The method of claim 8, wherein the selection criterion is based on the crypto wallet holding the digital asset or an owner associated with the crypto wallet.

10. The method of claim 8, wherein the selection criterion is based on a category type of the digital asset or a former crypto wallet address associated with the digital asset.

11. The method of claim 1, further comprising
providing a notification associated with a determination to deny the blockchain transaction;
receiving an override request to perform the blockchain transaction that was previously denied;
validating the override request; and
determining to allow the blockchain transaction that was previously denied.

12. The method of claim 11, wherein the override request is verified using a digital signature, a biometric signature, an override authorization code, or an identity verification certification.

13. A method of claim 1, further comprising:
providing one or more visual indicators associated with the transaction security option associated with the digital asset.

14. The method of claim 13, wherein the one or more visual indicators include a lock icon or a currency value.

15. The method of claim 13, wherein at least one of the one or more visual indicators is an interactive user interface element for initiating configuration of the transaction security option associated with the digital asset.

16. The method of claim 13, wherein at least one of the one or more visual indicators indicates that the transaction security option is inactive.

17. The method of claim 1, further comprising:
receiving a request to modify the transaction security option associated with the digital asset.

18. The method of claim 1, wherein the crypto wallet holding the digital asset is a multi-party computation (MPC) crypto wallet.

19. A system comprising:
one or more processors; and
a memory coupled to the one or more processors, wherein the memory is configured to provide the one or more processors with instructions which when executed cause the one or more processors to:
receive a request associated with a blockchain transaction for a digital asset;
determine that a crypto wallet holding the digital asset is associated with a transaction security option;
evaluate a transaction authorization rule associated with the transaction security option for verifying authorization for the blockchain transaction for the digital asset; and
based on the evaluation of the transaction authorization rule, determine whether to allow or deny the blockchain transaction for the digital asset.

20. A computer program product embodied in a non-transitory computer readable medium and comprising computer instructions for:
receiving a request associated with a blockchain transaction for a digital asset;
determining that a crypto wallet holding the digital asset is associated with a transaction security option;
evaluating a transaction authorization rule associated with the transaction security option for verifying authorization for the blockchain transaction for the digital asset; and
based on the evaluation of the transaction authorization rule, determining whether to allow or deny the blockchain transaction for the digital asset.
